(19) United States
(12) Patent Application Publication
(10) Pub. No.: US 2009/0231670 A1
(43) Pub. Date: Sep. 17, 2009

(54) DISPLAY ELEMENTS

(76) Inventors: Christopher L. Bower, Ely Cambridgeshire (GB); Christopher B. Rider, Hardwick Cambridgeshire (GB); John R. Fyson, Hackney London (GB); Elizabeth A. Simister, Watford Hertfordshire (GB); Andrew Clarke, Haslingfield Cambridge (GB)

Correspondence Address: EASTMAN KODAK COMPANY;PATENT LEGAL STAFF, 343 STATE STREET, ROCHESTER, NY, 14650-2201, US

(21) Appl. No.: 12/442,536

(22) PCT Filed: Oct. 15, 2007
(86) PCT No.: PCT/GB07/03883

§ 371 Date: Mar. 24, 2009

(30) Foreign Application Priority Data
Oct. 31, 2006 (GB) 0621635.2

(51) Int. Cl. G02B 26/00

(52) U.S. Cl. 359/290

(57) ABSTRACT

A device comprises one or more dielectric layers, one side of the layer or layers being conductive. A hydrophobic layer is provided on the other side of the dielectric layer. First and second fluids are located on the surface of the hydrophobic layer, the fluids being immiscible with each other. The first fluid comprises at least one ionic liquid. The conductive layer and first fluid are arranged such that they can be electrically connected.

### FIELD OF THE INVENTION

The present invention relates to the field of display elements, in particular to elements making use of the electrowetting principle.

### BACKGROUND OF THE INVENTION

There is a need to make low cost displays. One way to make displays inexpensive is to make them roll-to-roll. This implies that displays can be made on a large scale using traditional methods of coating and not requiring vacuum evaporation steps or the like. Some displays rely on the use of expensive liquid crystals, perhaps with a number of additional filter members such as polarizers and light coupling films. Avoiding the use of liquid crystal might be seen to be advantageous. One technology that might give means of roll-to roll manufacturing and without the need for liquid crystals is a display based on electrowetting on a flexible support.

A basic electrowetting optical element is described in EP1069450, “Optical element and optical device having it”. A further refinement to this concept using said element to create a pixel as part of an electrowetting display device is described in WO2004104670 “Display Device”. These devices switch when a potential is applied that causes a conducting solution to push aside a non-conducting oil that is usually coloured with a dye or pigment. When the voltage is removed the liquids relax and the oil covers the whole pixel again.

The manufacture of a low cost electrowetting display on a support requires air-tight sealing of the two-phase liquid system between two electrodes. The seal not only confines the liquids within the display, but is also required to prevent evaporative loss of the two liquid phases, particularly the water phase, since this has the larger volume and surrounds the oil phase. The water phase is required to have a large electrical conductance. This is normally achieved by the addition of salt such as KCl.

### SUMMARY OF THE INVENTION

According to the present invention there is provided a device comprising one or more dielectric layers, one side of the layer or layers being conductive, a hydrophobic layer on the opposing side of the dielectric layer, a first and a second fluid located on the surface of the hydrophobic layer, the fluids being immiscible with each other, the first fluid comprising at least one ionic liquid, and means for electrically connecting the conductive layer and the first fluid.

Preferably the support is flexible. However it will be understood by those skilled in the art that it is not necessary for the support to be flexible.

### ADVANTAGEOUS EFFECT OF THE INVENTION

Using an ionic liquid to replace the water phase solves the problem of requiring an airtight seal, due to the extremely low volatility of the ionic liquid. The ionic liquid does not evaporate. The seal need only be sufficient to confine the two liquid phases within the display. A further advantage of the invention is that the ionic liquid by its nature is intrinsically highly conductive. The ionic liquid has higher conductivity than using water with added ions. Therefore no additional salt need be added. In addition, the molecular structure can be tuned to optimise other properties such as viscosity, interfacial tension and immiscibility. Furthermore, the device construction is simplified and avoids problems such as crystallisation of any dissolved salt.

### BRIEF DESCRIPTION OF THE DRAWINGS

The invention will now be described with reference to the accompanying drawing in which:

FIGS. 1A and 1B illustrate the basic minimum requirements to create an electrowetting element; and

FIG. 2 is a graph illustrating change in area of an oil drop against voltage.

### DETAILED DESCRIPTION OF THE INVENTION

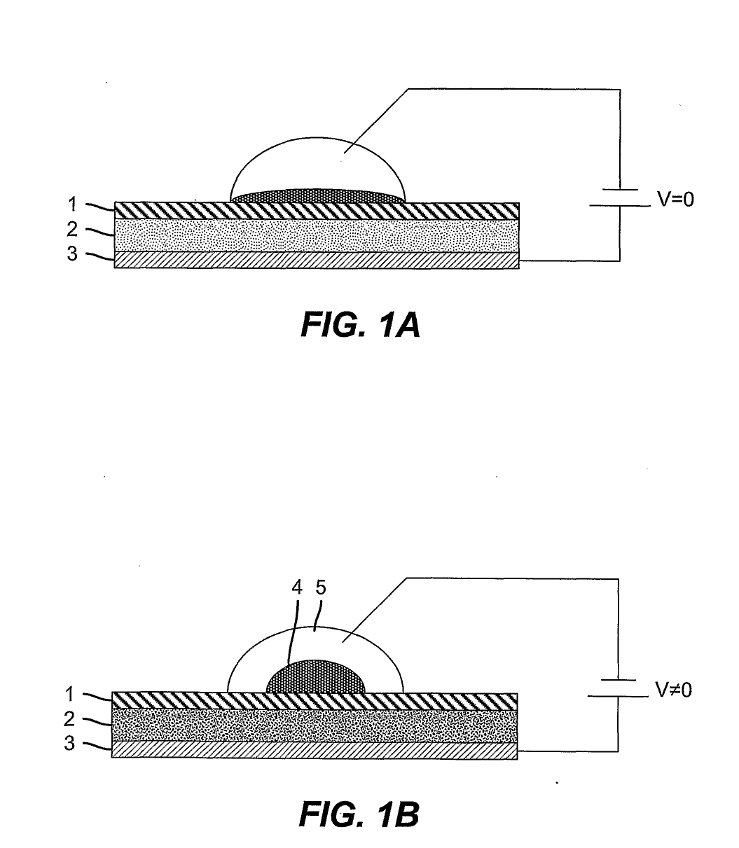

The basic minimum requirements to create an electrowetting pixel element or device on a support are shown in FIG. 1. A layer of hydrophobic material 1 is provided. This layer 1 has low surface energy. The material may be amorphous Teflon fluoropolymer AF1600 (Dupont) or a similar material. A layer 2 is provided below layer 1. Layer 2 is a support, which in this embodiment also acts as a dielectric layer. The device may include more than one dielectric layer. Layer 3 is a conducting layer that forms the bottom electrode. In this embodiment the layer 3 is a layer of sputter coated platinum of approximately 10 nm thickness. It will be appreciated by those skilled in the art that any other suitable material may be used. A droplet of oil 4 such as decane is placed on top of this layered structure. The structure need not be planar. For instance a textured structure could be fabricated to take advantage of superhydrophobicity effects. The droplet 4 is coloured using an oil-soluble, water-insoluble dye such as Oil Blue. The droplet is dielectric with low conductivity. A conducting liquid 5 is placed on top of the oil droplet. The conducting liquid is immiscible with the oil droplet. The conducting liquid is usually water with ions dissolved therein. In the absence of applied voltage between the conducting layer 3 and an electrode in contact with the conductive liquid (not shown) the oil drop 4 spreads to cover the hydrophobic layer 1. This is illustrated in FIG. 1A. When either a DC or AC voltage is applied between the lower conducting layer 3 and the electrode the area of the oil drop in contact with the hydrophobic layer 1 decreases and the contact angle of the oil droplet increases, i.e. the interface between the droplet 4 and the conductive liquid 5 changes. This can be seen in FIG. 1B. The change in contact angle is described by the Young-Lippman equation,

$$cos θ = cos {θ}_{0} + \frac{ɛ {V}^{2}}{2 {γ}_{LV} d}$$

where θ₀ is contact angle in the absence of applied voltage and θ the voltage dependent contact angle, ∈ the dielectric constant of the layers of thickness d, and γ_{LV} is the interfacial tension between the oil and water solutions.

### EXAMPLE

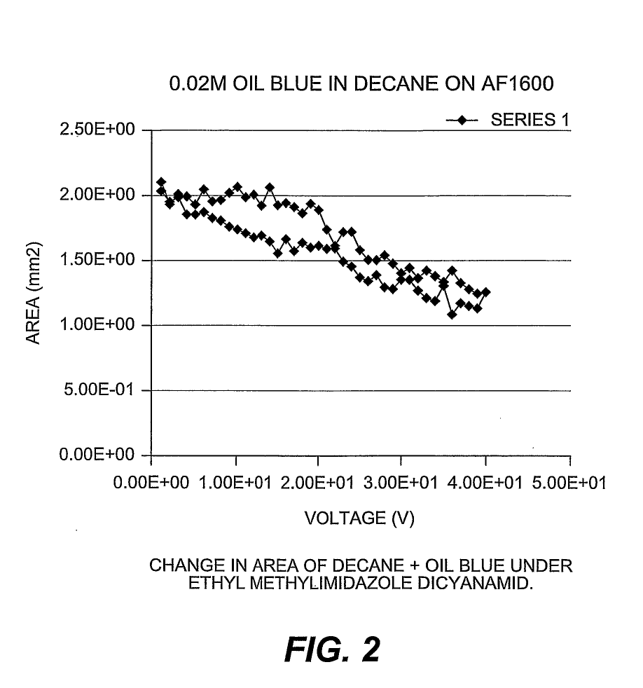

An experiment using the arrangement as described above was used. In accordance with the invention the conductive water phase was replaced by an ionic liquid, in this example Ethyl Methylimidazole dicyanamid (EMIM DCA). It will be understood by those skilled in the art that any suitable ionic liquid may be used. The ionic liquid used has a low viscosity, is highly conductive and is non-volatile. The change in area of the decane drop with applied DC voltage is shown in FIG. 2.

In a preferred embodiment the support layer is flexible. However this is not an essential feature of the invention. The support layer may equally be rigid. Possible rigid supports include glass and silica, metal, silicon or any other semiconductor material. It will be understood by those skilled in the art that any suitable material may be used for the support layer.
The conductive liquid may be a single ionic liquid or it may be a mixture of more than one ionic liquid. Alternatively the conductive liquid may be an ionic liquid in combination with other non-ionic liquids. An ionic liquid is defined as salts or mixtures of salts whose melting point is below 100° C. (P. Wasserscheid, W. Keim, Angew. Chem. (2001), 112, 3926). Liquid salts of this type known from the literature consist of anions, such as halostannates, haloaluminates, hexafluorophosphates or tetrafluoroborates combined with substituted ammonium, phosphonium, pyridinium or imidazolium cations. Further examples might include the use of cations such as; quaternary ammonium; phosphonium cation; imidazolium cation; pyridinium cation; pyrazolium cation and triazolium cation. Further examples may include the use of anions such as; halides, bis(perfluoroalkylsulphonyl)amides, alkyltosylates und aryltosylates, perfluoroallyltosylates, nitrates, sulphates, hydrogensulphates, allylsulphates and arylsulphates, perfluoroallylsulphates, sulphonates, alkylsulphonates and arylsulphonates, perfluorinated alkylsulphonates and arylsulphonates, alkylcarboxylates and arylcarboxylates, perfluoroalkylcarboxylates, perchlorates, tetrachloroaluminates, saccharinates, in particular dicyanamide, tetrafluoroborate, hexafluorophosphate and phosphate.

The dye in the oil may be a liquid or a pigment.

Using the ionic liquid on top of the decane+dye drop meant that the system was not destroyed by evaporation and was stable for several days. In contrast, a similar experiment using water+0.1M KCL as the conductive liquid top layer was only stable for a period of order tens of minutes, due to evaporation of the water.

The invention has been described in detail with reference to preferred embodiments thereof. It will be understood by those skilled in the art that variations and modifications can be effected within the scope of the invention.

1. A device comprising one or more dielectric layers, one side of the layer or layers being conductive, a hydrophobic layer on the opposing side of the dielectric layer, a first and a second fluid located on the surface of the hydrophobic layer, the fluids being immiscible with each other, the first fluid comprising at least one ionic liquid, and means for electrically connecting the conductive layer and the first fluid.

2. A device as claimed in claim 1 wherein the one or more dielectric layers are flexible.

3. A device as claimed in claim 1 wherein the ionic liquid has low viscosity.

4. A device as claimed in claim 1 wherein the ionic liquid has a low molecular weight.

5. A device as claimed in claim 1 wherein the dielectric layer and the hydrophobic layer are formed of the same material.

6. A device as claimed in claim 1 wherein both fluids are liquids.

7. A device as claimed in claim 1 wherein the liquid layer is divided by partition means into a number of individual elements each of which contains the two fluids and whereby the first fluid in each element is individually electrically addressable.

8. A device as claimed in claim 1 wherein the entire device is flexible.

9. A display device comprising at least one device as claimed in claim 1.

10. A method of providing an indicator or display comprising providing one or more dielectric layers, one side of the layer or layers being conductive, providing a hydrophobic layer on the opposing side of the dielectric layer, providing a first and a second fluid on the surface of the hydrophobic layer, the fluids being immiscible with each other and the first fluid comprising at least one ionic liquid, and applying a potential between the conductive layer and the first fluid such that the interface between the first and second fluid changes.

11. A method as claimed in claim 10 wherein the one or more dielectric layers provided are flexible.
